(19) United States
(12) Patent Application Publication
(10) Pub. No.: US 2008/0241544 A1
(43) Pub. Date: Oct. 2, 2008

(54) DISPERSION OF METAL OXIDE FINE PARTICLES AND METHOD FOR PRODUCING THE SAME

(75) Inventors: Yoshio Tadakuma, Kanagawa (JP); Yoichi Maruyama, Kanagawa (JP); Kimiyasu Morimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/054,475

(22) Filed: Mar. 25, 2008

(30) Foreign Application Priority Data
Mar. 29, 2007 (JP) 2007-086764

(51) Int. Cl. B32B 15/02; B05D 7/00

(52) U.S. Cl. 428/404; 427/215

(57) ABSTRACT

To provide a method for producing a dispersion of metal oxide fine particles including subjecting a titanium oxide precursor to heat treatment in the presence of an acid so as to prepare a dispersion of titanium oxide fine particles, mixing a metal oxide precursor with the dispersion of titanium oxide fine particles so as to form a mixture, and subjecting the mixture to heat treatment so as to form metal oxide fine particles, wherein the titanium oxide fine particles have a particle diameter of 0.5 nm to 5 nm.

### BACKGROUND OF THE INVENTION

1. Field of the Invention

The present invention relates to a dispersion of metal oxide fine particles having a highly refractive core-shell structure, and an efficient method for producing the same at low temperature in a short time.

2. Description of the Related Art

Metal oxides are often employed as inorganic materials for use in organic-inorganic hybrid materials that require high transparency. This is because they offer low absorption levels of visible light due to their large band gap. While metal hydroxides also have high transparency, some of them are difficult to handle because they easily form gel structure when prepared as a dispersion liquid. Moreover, since metal hydroxides are generally less stable than metal oxide fine particles in a dispersion state, the presence of metal hydroxide triggers time-dependent quality changes. Therefore, the adjustment of the amount of metal oxide fine particles plays an important role for preparation of highly transparent, highly refractive organic-inorganic hybrid materials. However, it is sometimes the case where low-temperature synthesis results in the formation of hydroxide and/or hydrate, depending on the nature of metal oxide. In this case, the hydroxide and/or hydrate synthesized at low temperature is converted into an oxide by autoclave treatment, calcination, or reflux in a high-boiling point solvent. This type of synthesis method, however, requires special equipment and longer times for temperature elevation or reduction, significantly increasing the process time and production costs.

For example, a method for producing a metal oxide in solution is known in which a metal hydroxide formed by hydrolysis at room temperature is subjected to hydrothermal treatment using an autoclave to obtain a metal oxide. Japanese Patent Application Publication (JP-B) No. 5-86605 discloses a method of producing tin-antimony oxide sol by adding an aqueous solution of ammonium bicarbonate a mixed solution of tin(II) chloride and antimony trichloride so as to form a co-precipitate gel (hydroxide) of tin and antimony, and by subjecting the gel to hydrothermal treatment.

Moreover, there is a method of synthesizing a crystalline metal oxide sol by synthesizing a metal oxide precursor at room temperature, mixing it with a water-soluble salt, drying and sintering the mixture for crystallization, and then again dispersing it in an aqueous solution. For example, Japanese Patent Application Laid-Open (JP-A) No. 2006-16236 discloses preparing a zirconium oxide by preparing a zirconium oxide precursor at room temperature, mixing it with a water-soluble salt, drying the mixture to form a solid article, and then subjected it to heat treatment using a baking furnace.

As described above, metal oxides are often crystallized by high-temperature heat treatment of a precursor that has been prepared at room temperature. Therefore, a heating step using an autoclave or the like needs equipment that can withstand high temperature, high pressure conditions, and/or requires longer times for temperature elevation or reduction, increasing the production costs. Moreover, particles becomes likely to aggregate by high temperature treatment to form larger secondary particles, and thus an additional step such as filtration becomes necessary to remove such secondary particles. This increases the number of steps and decreases yield, and thereby resulting in further higher costs.

### BRIEF SUMMARY OF THE INVENTION

The present invention aims to solve the problems pertinent in the art and to achieve the following object. Specifically, an object of the present invention is to provide a dispersion of metal oxide fine particles having a highly refractive core-shell structure and excellent dispersion stability and an efficient, inexpensive method for producing the dispersion of metal oxide fine particles at low temperature in a short time.

The present invention is based on the above-mentioned findings by the inventors of the present invention and the means for solving the above-mentioned problems is as follows:

<1> A method for producing a dispersion of metal oxide fine particles including subjecting a titanium oxide precursor to heat treatment in the presence of an acid so as to prepare a dispersion of titanium oxide fine particles, mixing a metal oxide precursor with the dispersion of titanium oxide fine particles so as to form a mixture, and subjecting the mixture to heat treatment so as to form metal oxide fine particles, wherein the titanium oxide fine particles have a particle diameter of 0.5 nm to 5 nm.

<2> The method for producing a dispersion of metal oxide fine particles according to <1>, wherein the metal oxide fine particles have a core-shell structure in which the core consisting of the titanium oxide fine particles is coated with the metal oxide.

<3> The method for producing a dispersion of metal oxide fine particles according to <2>, wherein the metal oxide contains any of a tin oxide, zirconium oxide, hafnium oxide and combinations thereof.

<4> The method for producing a dispersion of metal oxide fine particles according to any of <1> to <3>, wherein the metal oxide fine particles have an average particle diameter of 1 nm to 20 nm.

<5> A dispersion of metal oxide fine particles produced by the method according to any one of <1> to <4>.

The present invention can solve the conventional problems in the art and can provide a dispersion of metal oxide fine particles having a highly refractive core-shell structure and excellent dispersion stability and an efficient, inexpensive method for producing the dispersion of metal oxide fine particles at low temperature in a short time.

### DETAILED DESCRIPTION OF THE INVENTION

### (Method for Producing a Dispersion of Metal Oxide Fine Particles and a Dispersion of Metal Oxide Fine Particles)

A method of the present invention for producing a dispersion of metal oxide fine particles includes a step of preparing a dispersion of titanium oxide fine particles and a step of forming metal oxide fine particles and further includes other step(s), if necessary.

A dispersion of metal oxide fine particles of the present invention is produced by the method for producing a dispersion of metal oxide fine particles.

The dispersion of metal oxide fine particles of the present invention will be described in detail through an illustration of the method of the present invention for producing a dispersion of metal oxide fine particles.

In the dispersion of metal oxide fine particles, the metal oxide fine particles contain titanium oxide fine particles as a core, and have a core-shell structure in which a core is coated with the metal oxide.

Examples of the metal oxides include a tin oxide, zirconium oxide, hafnium oxide and combinations thereof.

### <Step of Preparing a Dispersion of Titanium Oxide Fine Particles>

The step of preparing a dispersion of titanium oxide fine particles is a step in which a titanium oxide precursor is subjected to heat treatment in the presence of acid, and a carboxylic compound may be added as necessary, so as to prepare a dispersion of titanium oxide fine particles, forming a core.

### —Titanium Oxide Precursor—

Examples of the titanium oxide precursors include titanium salts, titanium hydroxides and titanium alkoxide compounds.

Examples of the titanium hydroxides include amorphous titanium hydroxides in which a titanium tetrachloride solution is neutralized with an alkaline solution.

Examples of the titanium alkoxide compounds include tetramethoxytitanium, tetraethoxytitanium, tetrapropoxytitanium, tetraisopropoxytitanium, tetrabutoxytitanium, tetraisobutoxytitanium, tetrakis(2-methylpropoxy)titanium, tetrakis pentoxy titanium, tetrakis(2-ethylbutoxy)titanium, tetrakis(octoxy)titanium and tetrakis(2-ethylhexoxy)titanium. The titanium alkoxide compounds (tetraalkoxytitanium) having an alkoxyl group with many carbon atoms may not sufficiently undergo hydrolysis. On the other hand, if the number of carbon atoms in the alkoxyl group is too small, the reactivity becomes so high that it may become difficult control reaction. Therefore, tetrapropoxytitanium and tetraisopropoxytitanium are particularly preferred.

### —Acid—

Examples of acids include nitric acid, perchloric acid, hydrochloric acid, sulfuric acid, HBr water, HI water, HPF₆, HClO₃ and HIO₄.

The acid content of the dispersion of metal oxide fine particles differs depending on kinds and sizes of produced metal oxide fine particles and cannot be generally defined, and it is preferably 0.1 mole to 1 mole, and more preferably 0.2 mole to 0.9 mole per 1 mole of metal.

### —Carboxylic Compound—

As the carboxylic compound, at least one selected from carboxylic acids, salts of carboxylic acids and carboxylic anhydrides are used.

### —Carboxylic Acid—

The carboxylic acid is not particularly limited, and may be appropriately selected depending on the purpose. Examples thereof include saturated aliphatic carboxylic acids such as formic acid, acetic acid, propionic acid, butyric acid, isobutyric acid, valeric acid, isovaleric acid, pivalic acid, caproic acid, caprylic acid, capric acid, malonic acid, succinic acid, glutaric acid, adipic acid, pimelic acid and suberic acid; unsaturated aliphatic carboxylic acids such as acrylic acid, propiolic acid, methacrylic acid, crotonic acid, isocrotonic acid, maleic acid and fumaric acid; hydroxy carboxylic acids such as lactic acid, tartaric acid, malic acid and citric acid. These may be used alone or in combination of two or more.

The amount of the carboxylic acid in the aqueous dispersion of metal oxide fine particles differs depending on the kinds or sizes of produced metal oxide fine particles and cannot be generally defined, and it is preferably 0.15 mole to 3 mole per 1 mole of metal. —Salt of Carboxylic Acid—

By dissociation of salt, the salts of carboxylic acids substantially show the same effect as corresponding carboxylic acids.

Examples of the carboxylic acids in the salts of carboxylic acids include those described in the carboxylic acids.

In the salts of carboxylic acids, examples of parts other than the carboxylic acid include Li, Na, K, NH₄, NH₃CH₂CH₂OH, NH₂(CH₂CH₂OH)₂ and NH(CH₂CH₂OH)₃.

The amount of the salt of carboxylic acid in the dispersion of metal oxide fine particles differs depending on kinds or sizes of produced metal oxide fine particles and cannot be generally defined, and it is preferably 0.15 mole to 3 mole per 1 mole of metal.

### —Carboxylic Anhydride—

In an aqueous solution, the carboxylic anhydride, in which 2 molecules of carboxylic acid are condensed by losing one molecule of water, substantially shows the same effect as corresponding carboxylic acids.

The carboxylic anhydride is not particularly limited and may be appropriately selected depending on the purpose. Examples of the carboxylic anhydrides include acetic anhydrides, propionic anhydrides, succinic anhydrides, maleic anhydrides and phthalic anhydrides. These may be used alone or in combination of two or more.

The amount of the carboxylic anhydride in the dispersion of metal oxide fine particles differs depending on kinds and sizes of produced metal oxide fine particles and cannot be generally defined, and it is preferably 0.075 mole to 1.5 mole per 1 mole of metal.

### —Dispersing Solvent—

As a dispersing solvent, water is used, and other solvents can be added, if necessary. The solvents other than water are preferably compatible with water. Examples thereof include alcohols, ketones, aldehydes, ethers and esters.

Examples of alcohols include methanol, ethanol, propanol, isopropanol and butanol.

Examples of ketones include acetone and methyl ethyl ketone.

Examples of ethers include dioxane and diethyl ether.

—Heat treatment—

The heat treatment is preferably performed using a water bath at 40° C. to 95° C. for 5 minutes to 240 minutes.

Specifically, an acid is added in an aqueous solution of a titanium alkoxide compound at room temperature and stirred for 30 minutes, water is added, and then subjected to heat treatment to prepare a dispersion of titanium oxide fine particles. Before or after the heat treatment, a carboxylic compound may be added.

As the carboxylic compound, any one appropriately selected from those described above may be used. Examples thereof include acetic acid, propionic acid, malic acid, butyric acid and salts thereof and succinic anhydride.

The obtained titanium oxide fine particles serving as a core have a particle diameter of 0.5 nm to 5 nm. When the particle diameter is more than 5 nm, catalytic activity of the titanium oxide as a core is decreased and efficiency of forming a shell may be decreased.

The particle diameter of the titanium oxide fine particles can be measured as follows: the obtained dispersion is dropped onto a carbon-deposited copper mesh (micro-grid), dried, and observed using a transmission electron microscope, and then the observed image is printed in a photo negative. The photos of different views of 300 particles are obtained in total. These images of photo negatives are in the KS300 system (from Carl Zeiss) and an equivalent circular diameter of each particle is determined by image processing to find their particle diameter.

The titanium oxide fine particles may preferably be crystalline. For example, titanium oxide fine particles preferably have an anatase or rutile structure.

Here, as a common method, X-ray diffraction spectrum method is used to confirm crystallinity of the titanium oxide fine particles by the consistency with the peak of a corresponding single crystal by using RINT 1500 from Rigaku Corporation (X-ray source: copper Kα ray, wavelength: 1.5418 Å).

### <Step of Forming Metal Oxide Fine Particles>

The step of forming metal oxide fine particles is a step in which a metal oxide precursor is mixed in the dispersion of titanium oxide fine particles obtained in the step of preparing the dispersion of titanium oxide fine particles, and then subjected to heat treatment so as to form metal oxide fine particles and form a shell.

After the dispersion of titanium oxide fine particles is prepared, the metal oxide precursor may be directly mixed in the dispersion of titanium oxide fine particles, or the metal oxide precursor is once dissolved in water, an organic solvent and then mixed in the dispersion of titanium oxide fine particles. Subsequently, the metal oxide fine particles grow around the titanium oxide fine particles as a core by heat treatment.

As the metal oxide precursor, for example, any of an organic metal compound, a metal salt and a metal hydroxide is used. The metal oxide precursor may be solid or liquid, and preferably water soluble and treated as an aqueous solution.

A metal oxide constituting the metal oxide precursor is any of a tin oxide, a zirconium oxide, hafnium oxide and combinations thereof.

### —Metal Salt—

The metal component of the metal salt is a metal component of a corresponding metal oxide.

Examples of the metal salts include chlorides, bromides, iodides, nitrates, sulfates and organic acid salt of desired metals. Examples of the organic acid salts include acetate, propionate, naphthenate, octoate, stearate and oleate.

### —Metal Hydroxide—

Examples of the metal hydroxides include zirconium hydroxides, and a composite hydroxide of titanium and zirconium.

### —Organic Metal Compound—

Examples of the organic metal compounds include metal alkoxy compounds and metal acetylacetonate compounds.

Examples of the metal alkoxy compounds include alkoxyzirconiums.

Examples of alkoxyzirconiums include methoxyzirconium, ethoxyzirconium, propoxyzirconium, buthoxyzirconium, isobuthoxyzirconium and kis(2-methylpropoxy)zirconium. Of these, buthoxyzirconium is particularly preferred.

Regarding the metal alkoxide compounds other than alkoxy titaniums and alkoxy zirconiums, the metals in the metal alkoxide compound are preferably hafnium, aluminum, silicon, barium, tin, magnesium, calcium, iron, bismuth, gallium, germanium, indium, molybdenum, niobium, lead, antimony, strontium, tungsten and yttria. The alkoxides of these metals can be produced by reacting a metal alkoxide such as a potassium alkoxide and sodium alkoxide with a desired metal, as necessary.

### <Heat Treatment>

The heat treatment is preferably performed using a water bath at 40° C. to 95° C. for 5 minutes to 240 minutes.

### <Other Steps>

The washing method is not particularly limited and those known methods may be used as long as excess ions can be removed. Examples thereof include an ultrafiltration membrane method, a filtration separation method, a centrifugal separation-filtration method and an ion-exchange resin method.

The metal oxide fine particles having a core-shell structure produced by the method of the present invention for producing the fine metal oxide, preferably have an average particle diameter of 1 nm to 20 nm, and more preferably 3 nm to 10 nm. When the metal oxide fine particles have an average particle diameter of more than 20 nm, Rayleigh scattering is so large to cause haze, and thus application of the metal oxide fine particles may be often limited.

Here, the average particle diameter of the metal oxide fine particles may be found by measuring a 4 mass % aqueous solution of metal oxide fine particles directly on a particle diameter distribution analyzer, Microtrac from NIKKISO Co., Ltd. Alternatively, the dispersion was dropped onto a carbon-deposited copper mesh (microgrid) and dried, and then observed by using a transmission electron microscope to obtain a particle diameter. Specifically, images taken with a transmission electron microscope are either exposed to photo negatives or taken into a recording medium (for example, hard disk, etc.) as digital images, and then the images are printed large enough to observe particle diameters. The particle diameters can be found from these prints. Because the TEM image is a two dimensional image, it is difficult to obtain precise particle diameters, particularly in the case of non-spherical particles. However, the particle diameters can be found using the diameters of circles respectively having the same areas as project areas of 300 or more particles as two dimensional images (i.e., equivalent circular diameter).

### <Applications>

The dispersion of metal oxide fine particles of the present invention can be used as it is or condensed to be used as a dispersion. In addition, a binder component (resin component) is added to the dispersion of metal oxide fine particles to prepare a composition for film deposition (coating composition), and it is coated on a base material to form a fine particle dispersed film. Alternatively the dispersion of metal oxide fine particles is contained in a binder component (resin component) so as to prepare a resin composition for molding. Moreover, the dispersion of metal oxide fine particles is also prepared as a powder of fine particles by removing a solvent by concentration and drying, or centrifugation, and then by heating and drying.

The binder component is not particularly limited and may be appropriately selected depending on the purpose. Examples thereof include various kinds of synthetic resins such as thermoplastic or thermosetting resins (including thermosetting, ultraviolet curable, electron beam curable and moisture-curable resins, and combinations thereof), for example, silicon alkoxide binders, acrylic resins, polyester resins, fluorine resins, and organic binders such as natural resins. Examples of the synthetic resins include alkyd resins, amino resins, vinyl resins, acrylic resins, epoxy resins, polyamide resins, polyurethane resins, thermosetting unsaturated polyester resins, phenol resins, chlorinated polyolefin resins, silicone resins, acrylic silicone resins, fluorine resins, xylene resins, petroleum resins, ketone resins, rosin-modified maleic resins, liquid polybutadienes and coumarone resins. Examples of the natural resins include shellacs, rosins (pine resins), ester gums, hardened rosins, decolored shellacs and white shellacs. These may be used alone or in combination of two or more.

When the metal oxide fine particles are dispersed in a resin composition, the metal oxide fine particles are formulated with a dispersant, oil component, surfactant, pigment, preservative, alcohol, water, thickener or humectant, and used in various forms such as a dilute solution, tablet, lotion, cream, paste or stick, if necessary. The dispersant is not particularly limited and may be appropriately selected depending on the purpose. Examples thereof include a compound having a phosphoric acid group, a polymer having a phosphoric acid group, a silane coupling agent and a titanium coupling agent.

The dispersion of metal oxide fine particles of the present invention may be preferably used for optical filters, coatings, fibers, cosmetics, lenses or the like, because it has excellent dispersion stability and high transparency in the visible range and a certain wavelength range.

### EXAMPLES

Examples of the present invention will be described below, however, the present invention is not limited in scope to these Examples at all.

In Examples and Comparative Examples, particle diameter and X-ray diffraction were measured as follows:

### <Measurement of Particle Diameter by Transmission Electron Microscopy (TEM)>

The obtained dispersion was dropped onto a carbon-deposited copper mesh (microgrid), dried, and observed by using a transmission electron microscope, and then the observed image was printed in a photo negative. The photos of different views of 300 particles were obtained in total. These images of photo negatives were taken in the KS300 system (from Carl Zeiss) and an equivalent circular diameter of each particle was found by image processing to obtain particle diameters.

### <Measurement of X-Ray Diffraction (XRD) Spectrum>

X-ray diffraction spectrum was measured by using RINT 1500 from Rigaku Corporation (X-ray source: copper Kα ray, wavelength: 1.5418 Å).

### Example 1

15 ml of 35 mass % hydrochloric acid was added to 200 ml of water and stirred at room temperature (26° C.). 14 ml of titanium tetraisopropoxide (from Wako Pure Chemical Industries, Ltd.) was added therein and stirred for 20 minutes. The container loaded this mixture was put in a water bath at 80° C. and heated for 10 minute, and then 10 cc of acetic acid as a carboxylic compound was added for completion of synthesis, thereby producing a dispersion of titanium oxide fine particles (Dispersion A).

In Dispersion A, the titanium oxide fine particles had an average particle diameter of 3.4 nm as measured by TEM observation.

Next, a solution containing 16.59 g of tin(IV)chloride pentahydrate dissolved in 50 ml of water was mixed with Dispersion A at room temperature (26° C.) and subjected to heat treatment at 80° C. for 1 hour (Dispersion B).

In Dispersion B, the metal oxide fine particles had an average particle diameter of 4 nm found by TEM observation, and was found to be a crystalline tin oxide by X-ray diffraction.

### Example 2

First, a dispersion of titanium oxide fine particles was produced in the same manner as in Example 1 (Dispersion A).

Next, a solution containing 8.3 g of tin(IV)chloride pentahydrate dissolved in 50 ml of water was mixed with Dispersion A at room temperature (26° C.) and subjected to heat treatment at 80° C. for 1 hour (Dispersion C).

Then, 32 g of zirconium(IV)oxychloride octahydrate was dissolved in 50 ml of water at room temperature (26° C.), and then added in Dispersion C which was kept at 80° C and subjected to heat treatment at 100° C. for 4 hours.

The metal oxide fine particles had an average particle diameter of 5 nm found by TEM observation, and was found to be a tetragonal zirconium oxide by X-ray diffraction.

### Example 3

First, a dispersion of titanium oxide fine particles was produced in the same manner as in Example 1 (Dispersion A).

Next, 30.3 g of hafnium(IV)chloride was dissolved in 50 ml of water at room temperature (26° C.), and then added in Dispersion A which was kept at 80° C., and subjected to heat treatment at 100° C. for 4 hours (Dispersion D).

The obtained metal oxide fine particles had an average particle diameter of 5 nm, and were found to be amorphous by X-ray diffraction. However, an amorphous layer was found around a crystalline titanium oxide having an average particle diameter of 3.4 nm by TEM observation. Thus, an amorphous hafnium oxide was formed around the crystalline titanium oxide as a core.

### Comparative Example 1

A dispersion of tin oxide was produced in the same manner as in Example 1, except that 14 ml of isopropanol was mixed instead of 14 ml of titanium tetraisopropoxide (from Wako Pure Chemical Industries, Ltd.) (Dispersion E).

Dispersion E was observed by TEM and no particles were observed. The result of X-ray diffraction showed diffraction patterns of precipitated tin chloride.

### Comparative Example 2

9.7 g of zirconium(IV)oxychloride octahydrate was dissolved in 120 ml of water at room temperature (26° C.) without using a core of titanium oxide fine particles. While, 2.18 ml of ammonia water (36%) was dissolved in 30 ml of water, mixed well and prepared at room temperature. This solution was dropped into the solution of zirconium(IV)oxychloride octahydrate over 20 minutes, and then stirred for 60 minutes. This was subjected to heat treatment using an autoclave at 200° C. for 2 hours (Dispersion F).

Dispersion F was white turbidity, and metal oxide particles had an average primary particle diameter of approximately 8 nm, which formed aggregates having a diameter of approximately 50 nm. The result of X-ray diffraction showed that a zirconium oxide having mixed tetragonal and monoclinic systems.

### Comparative Example 3

A dispersion of titanium oxide fine particles was produced in the same manner as in production of Dispersion A of Example 1, except that the heating time was changed from 10 minutes to 60 minutes (Dispersion G).

The titanium oxide fine particles were found to have an average particle diameter of 10 nm by TEM observation. A solution of 16.59 g of tin(IV)chloride pentahydrate dissolved in 50 ml of water was mixed in Dispersion A at room temperature (26° C.) and subjected to heat treatment at 80° C. for 1 hour(Dispersion H).

In Dispersion H, the metal oxide fine particles had an average particle diameter of approximately 10 nm, and X-ray diffraction showed a precipitate of a crystalline tin oxide, and a tin chloride of a raw material.

TABLE 1

| | Core size | Final particle | |
|---|---|---|---|
| | of TiO₂ | diameter | Final product |
| Example 1 | 3.4 nm | 4 nm | tin oxide (crystal) |
| Example 2 | 3.4 nm | 5 nm | zirconium oxide (crystal) |
| Example 3 | 3.4 nm | 5 nm | hafnium oxide (amorphous) |
| Comparative | — | — | tin chloride (unreacted product) |
| Example 1 | | | |
| Comparative | — | 50 nm | zirconium oxide (crystal) |
| Example 2 | | | |
| Comparative | 10 nm | 10 nm | tin oxide (crystal) + tin |
| Example 3 | | | chloride (unreacted product) |

The dispersion of metal oxide fine particles of the present invention has a core-shell structure and is extremely transparent in the visible range and specific wavelength ranges, and therefore can be widely used as a very useful material for optical filters, coatings, fibers, cosmetics, lenses and the like.

What is claimed is:

1. A method for producing a dispersion of metal oxide fine particles comprising:
subjecting a titanium oxide precursor to heat treatment in the presence of an acid so as to prepare a dispersion of titanium oxide fine particles;
mixing a metal oxide precursor with the dispersion of titanium oxide fine particles so as to form a mixture; and
subjecting the mixture to heat treatment so as to form metal oxide fine particles,
wherein the titanium oxide fine particles have a particle diameter of 0.5 nm to 5 nm.

2. The method for producing a dispersion of metal oxide fine particles according to claim 1, wherein the metal oxide fine particles have a core-shell structure in which the core consisting of the titanium oxide fine particles is coated with the metal oxide.

3. The method for producing a dispersion of metal oxide fine particles according to claim 2, wherein the metal oxide comprises any of a tin oxide, zirconium oxide, hafnium oxide and combinations thereof.

4. The method for producing a dispersion of metal oxide fine particles according to claim 1, wherein the metal oxide fine particles have an average particle diameter of 1 nm to 20 nm.

5. A dispersion of metal oxide fine particles produced by a method for producing a dispersion of metal oxide fine particles, comprising:
subjecting a titanium oxide precursor to heat treatment in the presence of an acid so as to prepare a dispersion of titanium oxide fine particles;
mixing a metal oxide precursor with the dispersion of titanium oxide fine particles so as to form a mixture; and
subjecting the mixture to heat treatment so as to form metal oxide fine particles,
wherein the titanium oxide fine particles have a particle diameter of 0.5 nm to 5 nm.
